(19) United States
(12) Patent Application Publication
(10) Pub. No.: US 2008/0288218 A1
(43) Pub. Date: Nov. 20, 2008

(54) Using Tissue Acceleration to Create Better Dti Waveforms (Doppler Tissue Imaging) for Crt (Cardiac Resynchronization Therapy)

(75) Inventor: Karl E. Thiele, Andover, MA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,772

(22) PCT Filed: Oct. 24, 2006
(86) PCT No.: PCT/IB2006/053914

§ 371 Date: Apr. 28, 2008

Related U.S. Application Data
(60) Provisional application No. 60/730,637, filed on Oct. 27, 2005.

(51) Int. Cl. H04B 15/00

(52) U.S. Cl. 702/189

(57) ABSTRACT

The present invention allows one to reconstruct high quality velocity waveforms using data collected at comparatively slow frame rates, such data would have otherwise resulted in non-diagnostic and non-clinically useful waveforms. The invention is directed to reconstructing a high quality “continuous” velocity waveform, and uses instantaneous measures of acceleration in addition to velocity to reconstruct such a waveform. By simultaneously detecting the velocity and acceleration of a fixed point in space, one can more faithfully reproduce the corresponding velocity waveform using significantly lower sample rates. If images are acquired, then the velocity sample rate corresponds to the image frame rate. Also, depending on the number of looks or scan lines contained in an ensemble, double interleaving of the raw data is used.

This application claims the benefit of the filing date pursuant to 35 U.S.C. § 119(e) of provisional application Ser. No. 60/730,637, filed Oct. 27, 2005, the disclosure of which is hereby incorporated by reference.

The present invention generally relates to the field of Doppler Tissue Imaging (DTI) velocity images, and more particularly to methods of reconstructing high quality DTI velocity images using data obtained with comparatively slow frame rates.

DTI, which provides the velocity of the tissues in the direction of the probe, has been used in the ultrasound industry for almost 15 years, particularly in the area of echocardiography. Initial work in this area focused on Strain and Strain Rate imaging, particularly along the scan line direction. Strain and Strain Rate imaging provide an excellent measure of regional ventricular contraction. Recently, the simple DTI velocity waveforms (at different portions of the myocardial tissue) have been used directly for determining the contraction and relaxation timing of the left ventricle, particularly along the longitudinal axis, particularly with respect to other portions of the myocardium.

DTI involves firing energy along a line of sight or scan line, also known as a “look”, that is, a sound transmit event followed by an echo reception; a collection of scan lines used to form a 2D image is a frame. DTI ensembles, each being a group of round trip lines fired in the same scan line direction, e.g., multiple “looks” along the same scan line, are typically used to detect Doppler shifts off the echoes from blood and tissue (i.e. velocities). This Doppler shift can either be detected at one depth location along the scan line (e.g. Pulsed Wave Doppler) or multiple simultaneous locations (depths) along the scan line (e.g. Color Flow Doppler). The time between looks (usually measured in psec), Pulse Repetition Interval (PRI), which is the reciprocal of Pulse Repetition Frequency (PRF, i.e., PRI=1/PRF), is typically optimized by the clinician (person operating the machine) to detect the Doppler shift.

Cardiac resynchronization therapy (CRT), which is a new form of therapy for congestive heart failure, re-coordinates the beating of the two ventricles by pacing both simultaneously. Used for selected patients, this therapy provides benefits beyond a traditional pacemaker, which merely controls the beating of one heart ventricle. Additionally, CRT includes the therapy where 2 pacing leads are placed on different portions of a single ventricle (typically the left), to improve the synchronous contraction of the single ventricle.

The DTI velocity waveform can be quite complicated, and, as such, will have high temporal spectral frequency components. This waveform may contain 5 or more peaks relating to different phases of the cardiac cycle: iso-volumetric contraction, systolic contraction, iso-volumetric relaxation, E filling, and A filling. Because of this complexity, it has been suggested that frame rates of 100+ Hz might be needed to adequately capture these high frequency spectral components. To achieve this frame rate, the DTI ensembles are coarsely spaced in the lateral (azimuthal) dimension, and as a result, lateral resolution is severely compromised. For current clinical applications, these compromises are appropriate, since axial resolution, velocity accuracy, and waveform reconstruction of the longitudinal velocity are most important.

Currently, newer techniques, with the primary objective of tracking the radial and circumferential displacements and velocities of the myocardial tissue in the short axis orientation, are being proposed. This specifically refers to 2D and 3D speckle tracking techniques. The current clinical data collection and analysis techniques (such as Axius Velocity Vector Imaging by Siemens) rely on post-detected signals, and have clearly sacrificed their ability to detect and resolve fine displacements in the longitudinal dimension of the ventricle. U.S. Pat. No. 6,527,717, for example, discloses one such analysis technique, in which motion of the ultrasound transducer is accounted for in estimates at tissue motion. Movement of tissue is determined by correlating speckle, or a feature represented by two different sets of ultrasound data obtained at different times.

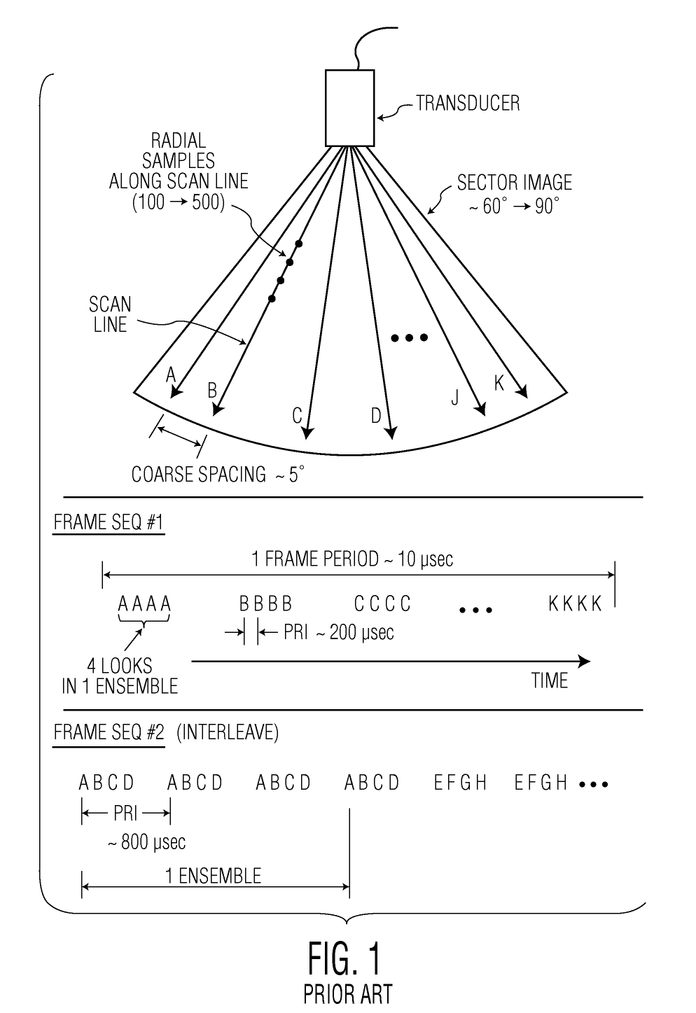

FIG. 1 is an example of the prior art relating to DTI. Radial samples are taken along scan lines A, B, . . . J, K, etc., which are coarsely spaced about 5 degrees apart. From 100 to 500 axial samples can be obtained along each scan line. Frame sequence #1, illustrating a frame period of approximately 10 msecs, shows four looks for each ensemble (AAAA, BBBB, etc.) The PRI for Frame Sequence #1 is approximately 200 μsecs. Frame Sequence #2 shows the interleaving of four looks (ABCD, ABCD, etc.) into one ensemble. This increases the PRI to approximately 800 μsecs, while maintaining the frame rate.

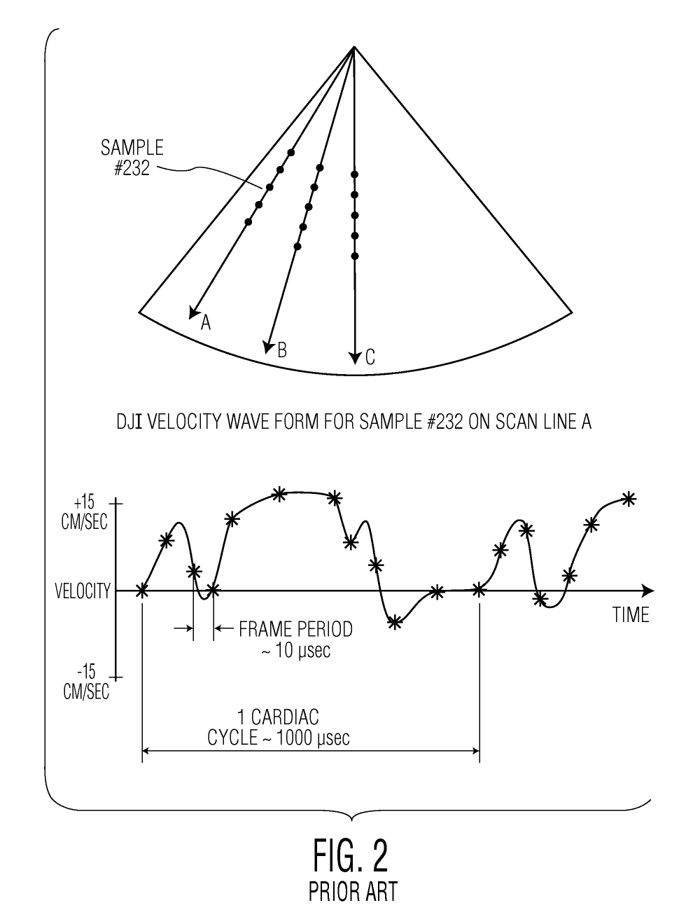

FIG. 2 shows a DTI Velocity waveform for sample #232 on scan line A of the DTI shown in FIG. 1. The illustrated waveform shows a cardiac cycle of approximately 1000 msecs; each frame period is about 10 msecs.

It would be desirable to increase the line density and resolution of the lateral dimension (for 2D speckle tracking), while preserving the spectral fidelity of the axial component. Unfortunately, increases in line densities and resolutions tend to result in slower frame rates (much less than 100 Hz), which will compromise the ability to resolve the high axial velocity spectral components. Furthermore, this decreased frame rate will be particularly severe when scanning volumes (3D Speckle tracking). In these cases, the use of only the velocity samples to reconstruct the waveform would result in an under-sampled and aliased velocity waveform.

The present invention allows one to reconstruct high quality velocity waveforms using data collected at comparatively slow frame rates, the data would have otherwise resulted in non-diagnostic and non-clinically useful waveforms. The invention overcomes the problem of decreased frame rate limiting available data for analysis found in the prior art.

The present invention is directed to reconstructing a high quality “continuous” velocity waveform, and uses instantaneous measures of acceleration in addition to velocity to reconstruct such a waveform. By simultaneously detecting the velocity and acceleration of a fixed point in space, as shown below, one can more faithfully reproduce the corresponding velocity waveform using significantly lower sample rates. If images are acquired, then the velocity sample rate corresponds to the image frame rate. Also, depending on the number of looks or scan lines contained in an ensemble, double interleaving of the raw data is used; this is described in detail below.

The inventive procedure is as follows. Using an ultrasound system, known in the art, undertake multiple firings or “looks” along one or more scan lines, each scan line being a one-dimensional pencil beam of sound interrogating a line in the body. The dimension has units of axial depth (e.g. cms), and the time between looks is known as the PRI. A DTI ensemble is a complete set or grouping of multiple looks which occur along the same scan line. Each resulting DTI ensemble may contain enough data to display a whole line, a complete image, or a complete volume of the tissue being examined by the ultrasound system. A complete image is obtained by firing multiple ensembles along displaced scan lines in the lateral dimension, whereas a complete volume is obtained by scanning multiple ensembles (multiple pencil beam directions) in both the lateral and elevation dimensions.

Begin with either the existing DTI ensemble/packet (if it includes at least three looks), or this packet with its count increased by one additional look, since at least three looks are necessary for acceleration to be determined. Next, calculate an instantaneous measure of the tissue acceleration (in the axial dimension) and calculate the regular DTI velocity estimate. These acceleration estimates, or instantaneous velocity slopes, in conjunction with the velocity samples, are then used to reconstruct a high quality “continuous” velocity waveform, as will be described in the preferred embodiment section. Parametric parameters can be derived from an internal representation of the reconstructed, continuous waveform, and these parameters may be applied to an image, showing such indications as start of contraction, time to peak contraction, etc.

The invention is further described in the detailed description that follows, by reference to the noted drawings by way of non-limiting illustrative embodiments of the invention. As should be understood, however, the invention is not limited to the precise arrangements and instrumentalities shown. In the drawings:

FIG. 1 is a schematic drawing of a prior art DTI;

FIG. 2 is a schematic drawing of the DTI waveform of the prior art DTI shown in FIG. 1;

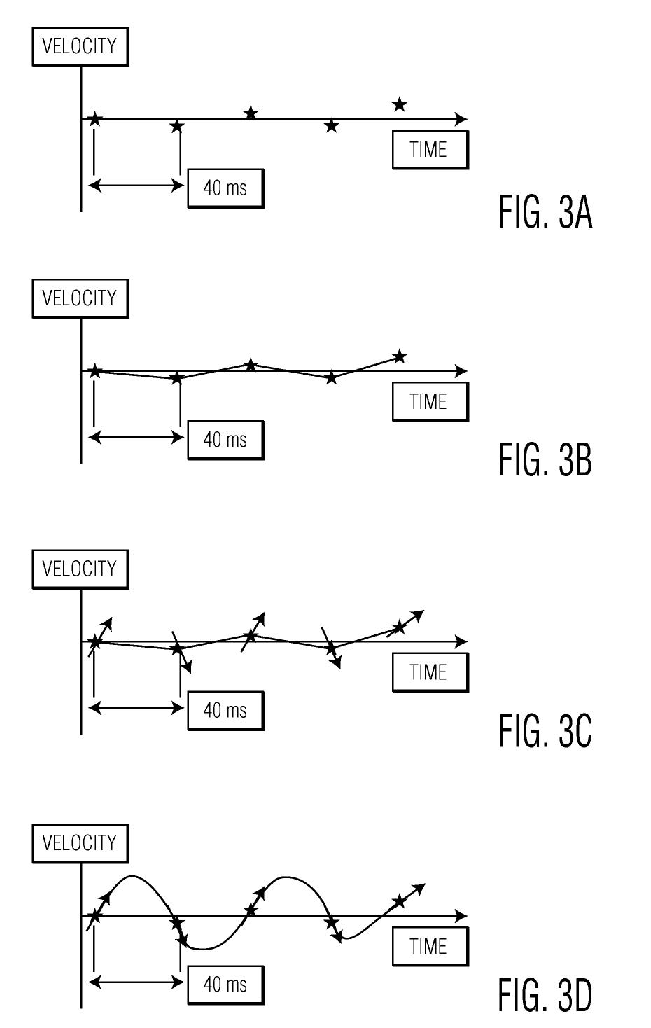

FIG. 3a shows an example of a severely undersampled velocity waveform;

FIG. 3b shows the waveform of FIG. 3a with the points connected;

FIG. 3c shows the waveform of FIG. 3a with the slope of the velocity waveform in addition to the velocity estimates;

FIG. 3d shows the waveform of FIG. 3a formed by using the slopes of FIG. 3c;

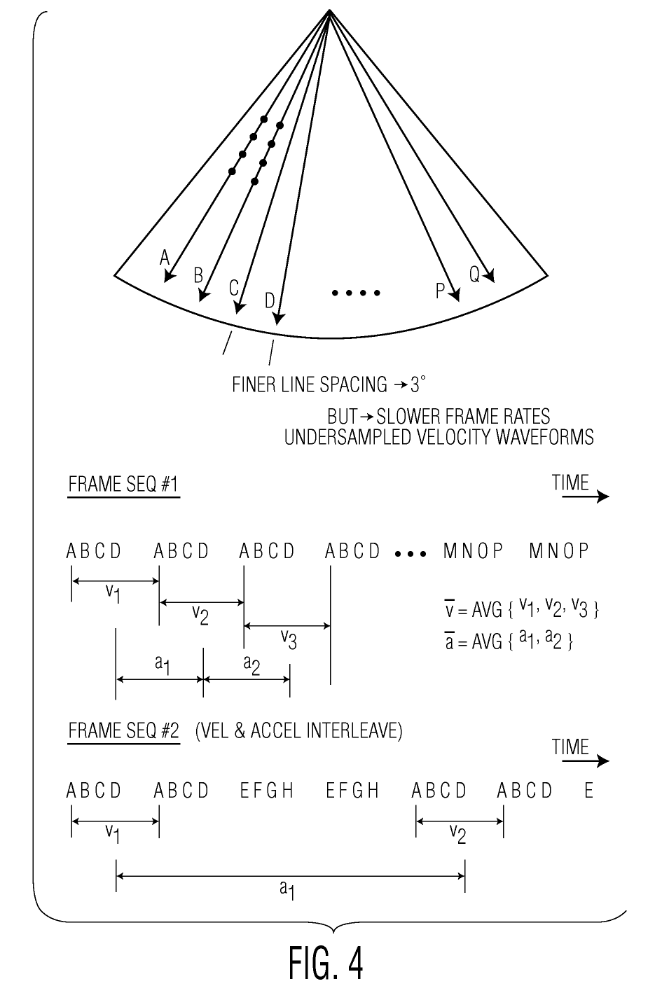

FIG. 4 shows an example of double interleaving in accordance with an embodiment of the present invention;

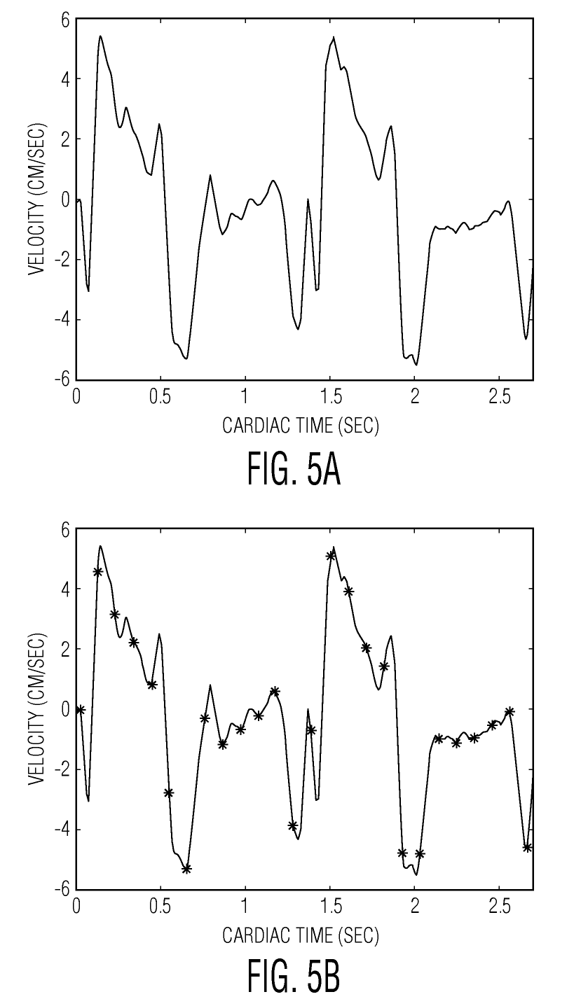

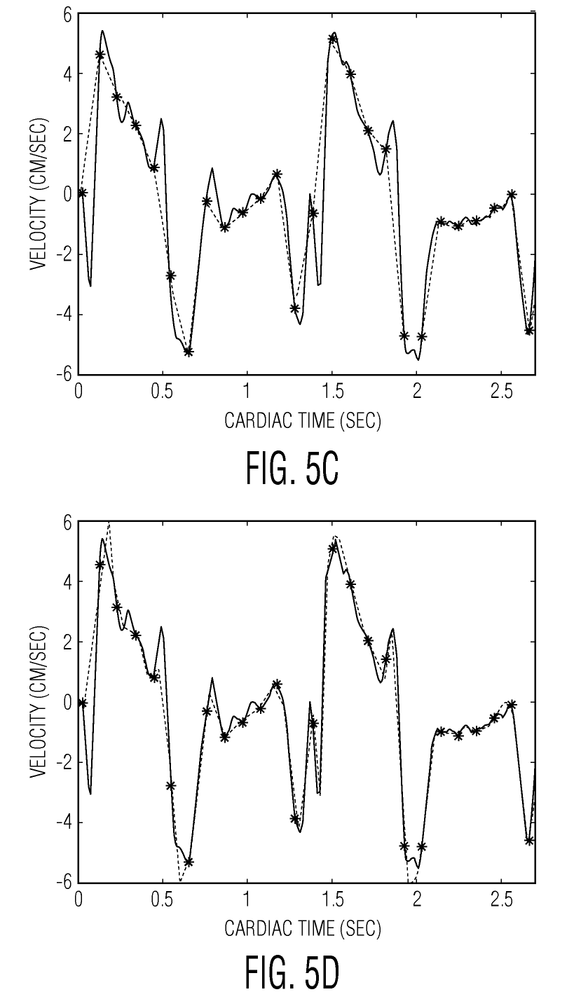

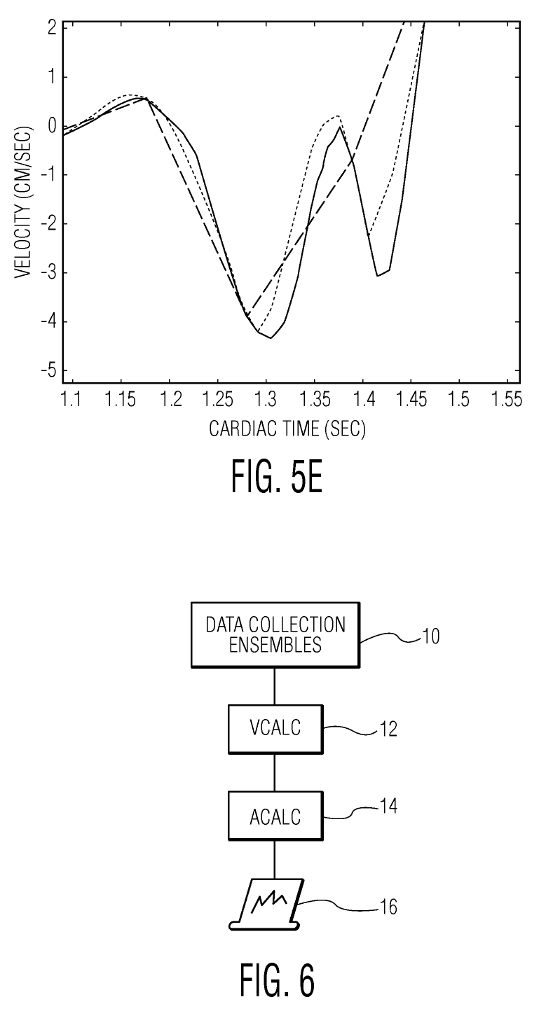

FIG. 5a shows a true myocardial velocity waveform;

FIG. 5b shows a true myocardial velocity waveform with undersampled velocity points;

FIG. 5c shows a true myocardial velocity waveform with a reconstructed waveform based on the undersampled velocity points;

FIG. 5d shows a true myocardial velocity waveform with an improved velocity reconstructed waveform based on the undersampled velocity points;

FIG. 5e shows a detail of a true myocardial velocity waveform along with reconstructed and improved reconstructed waveforms; and

FIG. 6 illustrates a system for reconstructing high quality velocity waveforms obtained at comparatively slow frame rates.

A method or system for reconstructing a high quality “continuous” velocity waveform, using acceleration in addition to velocity, is herein described. Initially, using an ultrasound system, collect data from firings or looks along one or more scan lines. Create DTI ensembles by combining or grouping multiple looks which occur along the same scan lines.

If the number of looks in a given ensemble is two, which is the minimum required to detect an instantaneous Doppler velocity, then an additional look must be obtained because the calculation of acceleration requires at least three looks. Once at least three looks are available, both velocity and acceleration can be calculated for every x, y point in the image. Standard Kasai technique, as disclosed, for example, in U.S. Pat. No. 4,622,977, teaches that the velocity of a Doppler shifted waveform can be calculated as follows:

$$v ( d , t ) = \frac{∠ \{ {\sum }_{i = 1}^{i = L - 1} {\tilde{u}}_{i + 1} ( d , t ) {\tilde{u}}_{i}^{*} ( d , t ) \}}{T} * \frac{λ / 2}{2 π} where \text{:}$$

$$d axial depth for given scan direction$$

$$t slow time ( corresponding to the \\ frame index or the phase of the cardiac cycle )$$

$$v instantaneous velocity \\ ( in cm \text{/} sec ) of tissue at depth d and time t$$

$${u}_{i} complex echo corresponding$$

$$to the “ {i}^{th} ” look of the ensemble$$

$$L Total \# of looks per ensemble$$

$$T P R I ( pulse repetition interval ) in seconds ( = 1 / PRF )$$

$$λ \text{/} 2 Wavelength of RF echo in$$

$$cm ( corresponding to RF center frequency ) ;$$

$$factoring “ λ \text{/} 2 ” to account for round trip$$

The number of axial samples for a given scan direction can be, for example, between 100 and 1000, with a typical 500 samples providing good results.

The tissue acceleration corresponding to a given point in space/time (at “d” and “t”) can be calculated as follows:

$$a ( d , t ) = \frac{∠ \{ {\sum }_{i = 1}^{i = L - 2} ( {\tilde{u}}_{i + 2} ( d , t ) {\tilde{u}}_{i + 1}^{*} ( d , t ) ) {( {\tilde{u}}_{i + 1} ( d , t ) {u}_{i}^{*} ( d , t ) )}^{*} \}}{{T}^{2}} * \frac{λ \text{/} 2}{2 π}$$

Accordingly, instantaneous measures of both the velocity and the acceleration can be computed. While the technique of measuring velocity, v(d,t), is known in the art (i.e. Kasai), calculating the instantaneous acceleration, a(d,t), as shown above is inventive, and can be used to provide an acceleration waveform, or tissue acceleration, to facilitate reconstruction and up-sampling of the corresponding under-sampled velocity waveform.

Undersampling occurs when “t” (slow time) is sampled at too slow a rate to adequately represent all of the details in the velocity waveform. Typically such sampling is illustrated by the following substitution of the continuous time variable t:

t=n * Tsample, where:
n=frame or sample index; and
Tsample=the time, in seconds, between adjacent samples

Thus, the continuous time velocity waveform (truth) is damaged by this undersampling process as follows:

v(d,t)→v(d, n*Tsample)=vₙ

Nyquist and sampling theory teach that the original continuous velocity signal can be exactly reconstructed if Tsample is small enough. This is shown as follows:

$${V}_{RECONSTRUCT} ( d , t ) = {\sum }_{ALLn} Vn * sin c ( \frac{t - n * Tsample}{Tsample} )$$

Such interpolation is usually simplified to just use simple linear interpolation between adjacent velocity samples (e.g. between vₙ and vₙ₊₁) such that:

$$Vsimple ( d , t ) = \frac{\begin{matrix}Vn * ( ( n + 1 ) * Tsample - t ) + \\ Vn + 1 * ( t - n * Tsample )\end{matrix}}{ \begin{matrix}Tsample for t between \\ n * Tsample and ( n + 1 ) * Tsample .\end{matrix}}$$

However, both ideal interpolation (using the sinc function) and simple linear interpolation will fail when the time between samples is too long, or the sampling interval is not short enough (i.e. when Tsample is too large). This can be shown graphically in FIG. 3a.

To overcome this data deficiency, this invention simultaneously uses both the under-sampled velocity data and the under-sampled acceleration data to produce a high quality, reconstructed velocity waveform. In its simplest form, this can be done as follows:

V_{BETTER}(d,t)={Vₙ}**hᵥ+{aₙ}**hₐ (Eq. 1)

### Where:

{Vₙ} sequence of velocity samples
** Convolution operator (used in FIR filtering)
hᵥ Velocity Reconstruction Impulse Response
{aₙ} sequence of acceleration samples
hₐ Acceleration Reconstruction Impulse Response

As shown in the following figure, appropriate “Reconstruction Impulse Responses” were calculated for both the velocity and acceleration samples. Note that the top curve corresponds to hᵥ and the bottom curve corresponds to hₐ. These responses are not unique. For the example reconstruction responses shown, it was assumed that the acceleration could be modeled by a second order polynomial, and constrained by the sample values. A full derivation of these curves is illustrated below.

In one embodiment, the time duration typically associated with the ensemble and the PRI may not be long enough to get a good estimate of acceleration. Thus a “double interleave” sequence, such that the velocity estimates use one interleave sequence (ping-pong factor), and the acceleration estimates use another, can be used. The objective of interleaving is to change the effective PRI observation time used to derive the velocity and acceleration estimates. FIG. 4, Frame Sequence #2, illustrates a double interleave in which the acceleration estimates have a longer PRI interval than the velocity estimates. FIG. 4 shows twelve scan lines labeled A, B, C, . . . P, Q. For the simple velocity calculation, as shown in FRAME SEQ #1, one interleave sequence is used, such that the PRI used for the instantaneous velocity estimates is the same as the PRI used for the instantaneous acceleration estimates. This is illustrated by the estimates v1, v2, v3 for velocity, and the estimates a1 and a2 for acceleration.

A likely problem with this scheme (same PRI's) is that rate of velocity change (i.e. acceleration) is relatively slow compared to time base (PRI) used to detect the velocity. For example, a typical PRI used to detect tissue velocity might be on the order of 1 msec. In this same period (same PRI), the expected change in the tissue velocity (i.e. acceleration) is expected to be very small, and as such, would preclude accurate measures of velocity. Therefore, a second and key aspect of this invention is the use of the “double interleave” sequence acceleration calculation, as shown in FRAME SEQ #2. This increases the time base (PRI_{ACCEL}) used to observe the instantaneous acceleration estimates, and decouples it from the PRI_{VEL} used to detect velocity. In FRAME SEQ #2, the first and second “A” sample are used to calculate the first instantaneous velocity estimate v1, and the third and fourth “A” sample are used to calculate the second instantaneous velocity estimate v. The time interval between the v1 and v2 velocity estimates is considerably longer than the velocity PRI, allowing for a more accurate acceleration estimate.

Using this method requires that the acceleration equation to be slightly modified as follows:

$$a ( d , t ) = \frac{∠ \{ {\sum }_{i = 1}^{i = L - 2} ( {\tilde{u}}_{i + j + 1} ( d , t ) {\tilde{u}}_{i + j}^{*} ( d , t ) ) {( {\tilde{u}}_{i + 1} ( d , t ) {\tilde{u}}_{i}^{*} ( d , t ) )}^{*} \}}{{T}^{2}} * \frac{λ \text{/} 2}{2 π}$$

where the factor “j” is “1” for the degenerate case (Acceleration PRI equals the Velocity PRI). Increasing “j” will increase the ability to detect smaller accelerations. In addition, another attribute of this process is that the above equations show that both the velocity and the acceleration estimates are averaged over the ensemble looks. Improved SNR and sensitivity can be further obtained by performing this average over space. Again, the result is a higher quality reconstructed DTI velocity waveform.

FIGS. 3a-3d illustrate that by simultaneously detecting both velocity and acceleration of a given point, a more faithful reproduction of the corresponding velocity waveform using significantly lower sample rates can be obtained. The advantage of using acceleration in addition to velocity to determine an appropriate waveform is thereby illustrated. FIG. 3a shows a velocity waveform having a frame rate of 25 Hz resulting in a severely undersampled velocity waveform. FIG. 3b shows this waveform with the points connected with straight line connections. FIG. 3c shows the acceleration, or slope of the velocity, of each point, and FIG. 3d shows that connecting the slopes yields a much more appropriate waveform.

FIGS. 5a-5e illustrate a Simulation using the inventive methodology. A True Myocardial Tissue Velocity waveform, for a single spatial point location, was acquired at a sample high frame rate of 200 Hz, as shown in FIG. 5a. By taking the first temporal derivative of this velocity waveform, a “truth” acceleration waveform was also calculated at the same high frame rate (not shown).

Subsequently, both waveforms were decimated to 10 Hz. These decimated samples are shown as stars on FIG. 5b. The purpose of this decimation is to simulate a clinical scenario where the tissue velocity was only observed at this very slow sampling rate. Using only these “star” samples, a “prior art” velocity waveform was reconstructed using only linear interpolation, and is shown as the dotted line in FIG. 5c. This dotted line (FIG. 5c) fails to capture the high frequency details of the “true” velocity waveform, and many of the sinusoidal components are simply ignored. See, for example, the loss of detail at around 1.4 seconds. Thus, the prior art interpolation, when using under-sampled velocity estimates, does a poor job of tracking the original “truth” waveform curve.

FIG. 5d illustrates the inventive process as a dotted line. This velocity waveform was reconstructed using both the velocity and acceleration estimates, and was reconstructed using the above equation Eq. 1 using the impulse responses shown in the above chart “Impulse Response Reconstruction Filters”. Although not all of the peaks are perfectly reproduced as seen in the “true” velocity waveform, shown as a solid line, the peaks can still be resolved. These peaks are indicative of key physiologic events, such as iso-volumetric contraction of the left ventricle.

FIG. 5e shows all the waveforms, true, interpolated and calculated by the inventive method, near the vicinity of 1.4 seconds, corresponding to the iso-volumetric contraction of the left ventricle. The solid line is the true myocardial tissue velocity, the stars are the undersampled velocity samples, the dashed line represents the prior art reconstructed velocity waveform using only linear interpolation of the velocity samples, and the dotted line illustrates the results of the inventive procedure. Note that the dotted line is a much more accurate reconstruction of the peaks and valleys of the original velocity waveform.

The math for the technique used to create the dotted line curve, and more specifically, the math used to create the impulse responses shown in the above chart “Impulse Response Reconstruction Filters”, to to create the inventive waveform shown in FIGS. 5d and 5e, is as follows. Construct a second order parabolic model for the acceleration (d+bt+ct̂2). Solve for d, b, c such that vo, ao and v1, a1 are valid. Note that vo and ao correspond to the 1^{st} undersampled observation at sample=0, and that v1 and a1 correspond to the 2^{nd} observation at sample=1. The purpose of this reconstruction is to determine the best expected values for the continuous velocity waveform between these two observations. This operation is then repeated for each consecutive pair of samples.

$$Let \text{:}$$

$$acceleration \text{:} a ( t ) = d + bt + {ct}^{2}$$

$$velocity \text{:} v ( t ) = Integrate \{ s ( t ) from 0 to t \} + vo$$

$$Noting that \text{:}$$

$$ao = d ( @ t = 0 )$$

$$a 1 = d + b + c ( @ t = 1 )$$

$$v 1 - vo = d + b \text{/} 2 + c \text{/} 3 ( @ t = 1 )$$

Solving first for b,c,d (the coefficients used in the acceleration parabolic model) we find:
d=ao
b=−4ao−2al+6dv
c=3ao+3al 6dv (dv=v1−v0)

Next, solving for v(t), as a function of vo,ao,v1,a1, we find:

v(t)=vo*(1−t)²*(1+2*t)+v1*t.²*(3−2t)+ao*t*(t−1)2+a1*(1−t)*t²

This expression can be seen as a simple FIR interpolation filter:

$$\begin{matrix}vCoefs = {( 1 - t )}^{2} * ( 1 + 2 * t ) & for 0 < t < 1 \\ = {( 1 + t )}^{2} * ( 1 - 2 * t ) & for - 1 < t < 0\end{matrix}$$

$$and$$

$$\begin{matrix}aCoefs = t * {( 1 - t )}^{2} & for 0 < t < 1 \\ = t * {( 1 + t )}^{2} & for - 1 < t < 0\end{matrix}$$

$$such that \text{:}$$

$$v ( t ) = v ( n ) ** vCoefs + a ( n ) ** aCoefs$$

Note that this is the same equation shown in Eq. 1.

FIG. 6 illustrates a system for performing DTI looks for creating DTI ensembles for reconstructing high quality velocity waveforms obtained at comparatively slow frame rates. A data collection device 10 such as an ultrasound machine performs DTI looks by firing energy along one or more scan lines. The data is grouped to form DTI ensembles and fed into a velocity calculator 12, such as a computer or other device which can perform complex mathematical calculations. Further, the data is fed into an acceleration calculator 14, the same or an additional computer or other device. Data is manipulated therein and the reconstructed high quality waveform can be displayed on a screen 16 or other device.

In the alternative, data can be stored or passed to another computer or computational device for additional processing. For example, parametric parameters can be derived from an internal representation of the waveform. These parameters may be applied to DTI or other images to show indications of incidents or actions of the heart chamber, such as start of contraction, time to peak contraction, etc.

The present invention has been described herein with reference to certain exemplary or preferred embodiments. These embodiments are offered as merely illustrative, not limiting, of the scope of the present invention Certain alterations or modifications may be apparent to those skilled in the art in light of instant disclosure without departing from the spirit or scope of the present invention, which is defined solely with reference to the following appended claims.

What is claimed:

1. A method for reconstructing high quality velocity waveforms obtained at comparatively slow frame rates, said method comprising:
performing at least three looks for creating a DTI ensemble;
calculating DTI velocity estimate using said DTI ensemble;
calculating instantaneous measure of tissue acceleration estimate using said DTI ensemble; and
reconstructing said velocity waveform using both said DTI velocity estimate and said tissue acceleration estimate.

2. The method for reconstructing high quality velocity waveforms according to claim 1, wherein said calculating DTI velocity estimate is done using Kasai techniques.

3. The method for reconstructing high quality velocity waveforms according to claim 1, wherein said calculating DTI velocity estimate is done using the formula
$$v ( d , t ) = \frac{∠ \{ {\sum }_{i = 1}^{i = L - 1} {\tilde{u}}_{i + 1} ( d , t ) {\tilde{u}}_{i}^{*} ( d , t ) \}}{T} * \frac{λ / 2}{2 π} , where \text{:}$$
$$d axial depth for given look direction$$
$$t slow time ( corresponding to the frame rate )$$
$$v velocity ( in cm \text{/} sec ) of tissue at depth d and time t$$
$${u}_{i} complex echo corresponding$$
$$to the “ {i}^{th} ” look of the ensemble$$
$$L Total \# of looks per ensemble$$
$$T P R I ( pulse repetition interval ) in seconds ( = 1 / PRF )$$
$$λ \text{/} 2 Wavelength of RF echo in cm \\ ( corresponding to RF center frequency )$$

4. The method for reconstructing high quality velocity waveforms according to claim 1, wherein said calculating tissue acceleration estimate is done using the formula
$$a ( d , t ) = \frac{∠ \{ {\sum }_{i = 1}^{i = L - 2} ( {\tilde{u}}_{i + 2} ( d , t ) {\tilde{u}}_{i + 1}^{*} ( d , t ) ) {( {\tilde{u}}_{i + 1} ( d , t ) {\tilde{u}}_{i}^{*} ( d , t ) )}^{*} \}}{{T}^{2}} * \frac{λ \text{/} 2}{2 π} , \\ where \text{:}$$
$$d axial depth for given look direction$$
$$t slow time ( corresponding to the frame rate )$$
$$v velocity ( in cm \text{/} sec ) of tissue at depth d and time t$$
$${u}_{i} complex echo corresponding$$
$$to the “ {i}^{th} ” look of the ensemble$$
$$L Total \# of looks per ensemble$$
$$T P R I ( pulse repetition interval ) in seconds ( = 1 / PRF )$$
$$λ \text{/} 2 Wavelength of RF echo in cm \\ ( corresponding to RF center frequency )$$

5. The method for reconstructing high quality velocity waveforms according to claim 1, wherein said calculating said tissue acceleration estimate is done by a cubic spline acceleration method.

6. The method for reconstructing high quality velocity waveforms according to claim 1, wherein said calculating said tissue acceleration estimate is done using a second order parabolic model.

7. The method for reconstructing high quality velocity waveforms according to claim 1, wherein the waveform is reconstructed at least one of a single point along a given scan direction, multiple points along the given scan direction, multiple points along multiple scan directions in two-dimensional space, and multiple points along multiple scan directions in three-dimensional space.

8. The method for reconstructing high quality velocity waveforms according to claim 1, further comprising calculating DTI velocity estimate and instantaneous measure of tissue acceleration using double interleaving of DTI ensemble.

9. The method for reconstructing high quality velocity waveforms according to claim 1, wherein said calculating said DTI velocity estimate is done using a first PRI interval and said calculating said tissue acceleration estimate is done using a second PRI interval, said first PRI interval being smaller than said second PRI interval.

10. A method for reconstructing DTI velocity waveforms created by performing DTI looks for forming DTI ensembles, said method comprising:
using three or more looks in an ensemble along a given scan line direction;
calculating DTI velocity estimate and instantaneous measure of tissue acceleration; and
reconstructing said waveform.

11. An article of manufacture comprising:
a computer usable medium having computer readable program code means embodied thereon for reconstructing high quality velocity waveforms, said computer readable program code means in said article of manufacture comprising:
computer readable program code to determine and store at least three looks;
computer readable program code to determine a DTI ensemble comprising the at least three looks;
computer readable program code to calculate a velocity estimate of said DTI ensemble;
computer readable program code to calculate an acceleration estimate of said DTI ensemble; and
computer readable program code to reconstruct said velocity waveforms from both said velocity estimate and said acceleration estimate.

12. The article as claimed in claim 11, wherein said calculating said velocity estimate is performed using standard Kasai techniques.

13. The article as claimed in claim 11, wherein said calculating said velocity estimate is performed using the formula
$$v ( d , t ) = \frac{∠ \{ {\sum }_{i = 1}^{i = L - 1} {\tilde{u}}_{i + 1} ( d , t ) {\tilde{u}}_{i}^{*} ( d , t ) \}}{T} * \frac{λ / 2}{2 π} , where \text{:}$$
$$d axial depth for given look direction$$
$$t slow time ( corresponding to the frame rate )$$
$$v velocity ( in cm \text{/} sec ) of tissue at depth d and time t$$
$${u}_{i} complex echo corresponding$$
$$to the “ {i}^{th} ” look of the ensemble$$
$$L Total \# of looks per ensemble$$
$$T P R I ( pulse repetition interval ) in seconds ( = 1 / PRF )$$
$$λ \text{/} 2 Wavelength of RF echo in cm \\ ( corresponding to RF center frequency )$$

14. The article as claimed in claim 11, wherein said calculating acceleration is performed using the formula
$$a ( d , t ) = \frac{∠ \{ {\sum }_{i = 1}^{i = L - 2} ( {\tilde{u}}_{i + 2} ( d , t ) {\tilde{u}}_{i + 1}^{*} ( d , t ) ) {( {\tilde{u}}_{i + 1} ( d , t ) {\tilde{u}}_{i}^{*} ( d , t ) )}^{*} \}}{{T}^{2}} * \frac{λ \text{/} 2}{2 π} , \\ where \text{:}$$
$$d axial depth for given look direction$$
$$t slow time ( corresponding to the frame rate )$$
$$v velocity ( in cm / sec ) of tissue at depth d and time t$$
$${u}_{i} complex echo corresponding$$
$$to the “ {i}^{th} ” look of the ensemble$$
$$L Total \# of looks per ensemble$$
$$T P R I ( pulse repetition interval ) in seconds ( = 1 / PRF )$$
$$λ \text{/} 2 Wavelength of RF echo in cm \\ ( corresponding to RF center frequency )$$

15. The article as claimed in claim 11, wherein said calculating said acceleration estimate is performed using a cubic spline acceleration method.

16. The article as claimed in claim 11, wherein said calculating acceleration is performed using a second order parabolic model.

17. The article as claimed in claim 11, wherein said calculating said velocity estimate is done using a first PRI interval and said calculating said acceleration estimate is done using a second PRI interval, said first PRI interval being smaller than said second PRI interval.

18. The computer readable storage medium as claimed in claim 17, wherein said calculating acceleration is performed using the formula
$$a ( d , t ) = \frac{∠ \{ {\sum }_{i = 1}^{i = L - 2} ( {\tilde{u}}_{i + j + 1} ( d , t ) {\tilde{u}}_{i + j}^{*} ( d , t ) ) {( {\tilde{u}}_{i + 1} ( d , t ) {\tilde{u}}_{i}^{*} ( d , t ) )}^{*} \}}{{T}^{2}} * \frac{λ \text{/} 2}{2 π} , \\ where$$
$$d axial depth for given look direction$$
$$t slow time ( corresponding to the frame rate )$$
$$v velocity ( in cm \text{/} sec ) of tissue at depth d and time t$$
$${u}_{i} complex echo corresponding$$
$$to the “ {i}^{th} ” look of the ensemble$$
$$L Total \# of looks per ensemble$$
$$T P R I ( pulse repetition interval ) in seconds ( = 1 / PRF )$$
$$λ \text{/} 2 Wavelength of RF echo in cm \\ ( corresponding to RF center frequency )$$

19. A system for performing DTI looks for creating DTI ensembles for reconstructing high quality velocity waveforms obtained at comparatively slow frame rates, said system comprising:
the DTI ensembles having at least three looks;
a velocity calculator for calculating velocity of said DTI ensemble; and
an acceleration calculator for calculating acceleration of said DTI ensemble, wherein said velocity calculator and said acceleration calculator determine said reconstructed high quality velocity waveforms.

20. The system for performing DTI looks according to claim 19, wherein said velocity calculator uses Kasai techniques.

21. The system for performing DTI looks according to claim 19, wherein said velocity calculator uses the formula
$$v ( d , t ) = \frac{∠ \{ {\sum }_{i = 1}^{i = L - 1} {\tilde{u}}_{i + 1} ( d , t ) {\tilde{u}}_{i}^{*} ( d , t ) \}}{T} * \frac{λ / 2}{2 π} , where \text{:}$$
$$d axial depth for given look direction$$
$$t slow time ( corresponding to the frame rate )$$
$$v velocity ( in cm \text{/} sec ) of tissue at depth d and time t$$
$${u}_{i} complex echo corresponding$$
$$to the “ {i}^{th} ” look of the ensemble$$
$$L Total \# of looks per ensemble$$
$$T P R I ( pulse repetition interval ) in seconds ( = 1 / PRF )$$
$$λ \text{/} 2 Wavelength of RF echo in cm \\ ( corresponding to RF center frequency )$$

22. The system for performing DTI looks according to claim 19, wherein said acceleration calculator uses the formula
$$a ( d , t ) = \frac{∠ \{ {\sum }_{i = 1}^{i = L - 2} ( {\tilde{u}}_{i + 2} ( d , t ) {\tilde{u}}_{i + 1}^{*} ( d , t ) ) {( {\tilde{u}}_{i + 1} ( d , t ) {\tilde{u}}_{i}^{*} ( d , t ) )}^{*} \}}{{T}^{2}} * \frac{λ \text{/} 2}{2 π} , \\ where \text{:}$$
$$d axial depth for given look direction$$
$$t slow time ( corresponding to the frame rate )$$
$$v velocity ( in cm \text{/} sec ) of tissue at depth d and time t$$
$${u}_{i} complex echo corresponding$$
$$to the “ {i}^{th} ” look of the ensemble$$
$$L Total \# of looks per ensemble$$
$$T P R I ( pulse repetition interval ) in seconds ( = 1 / PRF )$$
$$λ \text{/} 2 Wavelength of RF echo in cm \\ ( corresponding to RF center frequency )$$

23. The system for performing DTI looks according to claim 19, wherein said acceleration calculator uses a cubic spline acceleration method.

24. The system for performing DTI looks according to claim 19, wherein said acceleration calculator uses a second order parabolic model.

25. The system for performing DTI looks according to claim 19, wherein:
wherein said calculating said velocity estimate is done using a first PRI interval and said calculating said acceleration estimate is done using a second PRI interval, said first PRI interval being smaller than said second PRI interval.

26. The system for performing DTI looks according to claim 25, wherein said acceleration calculator uses the formula
$$a ( d , t ) = \frac{∠ \{ {\sum }_{i = 1}^{i = L - 2} ( {\tilde{u}}_{i + j + 1} ( d , t ) {\tilde{u}}_{i + j}^{*} ( d , t ) ) {( {\tilde{u}}_{i + 1} ( d , t ) {\tilde{u}}_{i}^{*} ( d , t ) )}^{*} \}}{{T}^{2}} * \frac{λ \text{/} 2}{2 π} , \\ where \text{:}$$
$$d axial depth for given look direction$$
$$t slow time ( corresponding to the frame rate )$$
$$v velocity ( in cm \text{/} sec ) of tissue at depth d and time t$$
$${u}_{i} complex echo corresponding$$
$$to the “ {i}^{th} ” look of the ensemble$$
$$L Total \# of looks per ensemble$$
$$T P R I ( pulse repetition interval ) in seconds ( = 1 / PRF )$$
$$λ \text{/} 2 Wavelength of RF echo in cm \\ ( corresponding to RF center frequency )$$
